(19) United States
(12) Patent Application Publication
(10) Pub. No.: US 2011/0183085 A1
(43) Pub. Date: Jul. 28, 2011

(54) Game Animal Sculpture Apparatus And Method

(75) Inventor: David E. Spiess, Greenwell Springs, LA (US)

(73) Assignee: AMERICAN WILDLIFE STUDIOS, INC., Greenwell Springs, LA (US)

(21) Appl. No.: 12/984,379

(22) Filed: Jan. 4, 2011

Related U.S. Application Data
(60) Provisional application No. 61/298,439, filed on Jan. 26, 2010.

(51) Int. Cl. B44C 5/02; G09F 19/00; A01N 1/00

(52) U.S. Cl. 428/16; 156/57

(57) ABSTRACT

A sculpture of at least a head portion of a game animal. The sculpture includes at least a re-created game animal head portion sculpted, textured, molded, and/or painted to substantially conform to the shape, dimensions and, optionally, color of at least the head portion of the game animal, wherein the re-created game animal head portion defines a cavity sized and configured to receive at least one appendage of the game animal. A cover is sized and configured to be positioned over at least a portion of the cavity, such that when the appendage is received in the cavity of the re-created animal head portion and the cover is disposed over the cavity, the sculpture substantially resembles at least the head portion of the game animal.

### REFERENCE TO RELATED APPLICATION

Claim is hereby made to the benefit of the priority of the filing date of U.S. Provisional Patent Appln. No. 61/298,439, filed on Jan. 26, 2010, the disclosure of which is incorporated herein by reference.

### TECHNICAL FIELD

This invention relates to the sculpture of game animals, more specifically, to the sculpture of game animals, wherein the sculpture includes at least one appendage from the game animal.

### BACKGROUND

Game animals, e.g., deer, elk, antelope, moose, boar, and the like, are typically hunted by sportsmen. After successfully hunting such game animals, some sportsmen prefer to have trophy mounts of the game animals prepared by a taxidermist in order to display such trophy mounts in their home, camp, lodge, office, or the like. In such cases, the trophy mounts have certain disadvantages, including the need for a climate controlled environment. Most camps or lodges are not climate controlled year round, which significantly shortens the life of the mounted game animal. Although the hide and fur may be treated by the taxidermist, such hide and fur are susceptible to decomposition, especially in humid environments.

### SUMMARY OF THE INVENTION

From the foregoing, it is apparent a need exists for a quickly and easily constructible, inexpensive apparatus and method of re-creating a game animal that may withstand humid conditions without affecting the aesthetic appeal and structural integrity of the re-created game animal. This invention provides such a solution to the foregoing need, amongst others, by providing in at least one aspect of the invention a sculpture of a game animal that may be constructed quickly and inexpensively by a sportsman, such sculpture being capable of withstanding adverse climate conditions.

An aspect of this invention is a sculpture of at least a head portion of a game animal. The sculpture includes at least a re-created game animal head portion sculpted, textured, molded, and/or painted to substantially conform to the shape, dimensions and, optionally, color of at least the head portion of the game animal, wherein the re-created game animal head portion defines a cavity sized and configured to receive at least one appendage of the game animal. A cover is sized and configured to be positioned over at least a portion of the cavity, such that when the appendage is received in the cavity of the re-created animal head portion and the cover is disposed over the cavity, the sculpture substantially resembles at least the head portion of the game animal.

Another aspect of this invention is a method of mounting at least one appendage of a game animal to a re-created game animal head portion of a sculpture of at least a head portion of the game animal. The method includes disposing a portion of each appendage in a cavity defined by the re-created game animal head portion, wherein the re-created game animal head portion is sculpted, textured, molded, and/or painted to substantially conform to the shape, dimensions and, optionally, color of at least the head portion of the game animal and the cavity is sized and configured to receive the portion of each appendage of the game animal. The method further includes attaching the portion of each appendage of the game animal to the re-created game animal head portion and disposing over the cavity a cover sized and configured to be positioned over at least a portion of the cavity, whereby the sculpture substantially resembles at least the head portion of the game animal.

These and other features of certain aspects of this invention will be still further apparent from the ensuing description, drawings, and appended claims.

### BRIEF DESCRIPTION OF THE DRAWINGS

FIG. 1 is a perspective view of a sculpture of a game animal, illustrated as a deer, in accordance with one aspect of the present invention.

FIG. 2 is a perspective view of the sculpture of the deer consistent with FIG. 1, wherein a flap is rotated about a hinged portion such that a cavity defined by the re-created deer head portion may be exposed and a unitary antler set may be disposed within the cavity.

FIG. 3 is an exploded perspective view of the sculpture of the game animal consistent with FIG. 1, wherein the flap is shown rotated about the hinged portion and the unitary antler set is shown detached from the re-created deer head portion.

FIG. 4 is an exploded perspective view of an alternate aspect of the present invention, wherein the cover is detachably attachable to the re-created deer head portion.

In each of the above figures, like numerals are used to refer to like or functionally like parts among the several figures.

### FURTHER DETAILED DESCRIPTION OF THE INVENTION

Illustrative implementations of the invention are described below as they might be employed in the construction and use of an apparatus and method for re-creating a game animal according to at least one implementation of the present invention. In the interest of clarity and conciseness, not all trivial features of an actual implementation are described in this specification. It will be of course appreciated that in the development of such an actual implementation of the same, numerous implementation-specific decisions must be made to achieve the developers' specific goals, such as compliance with system-related and business-related constraints, budgets, and so forth, which will vary from one implementation to another. Moreover, it will be appreciated that such a development effort might be complex and time-consuming, but would nevertheless be a routine undertaking for those of ordinary skill in the art having the benefit of this disclosure.

The present invention relates to a sculpture of at least a portion of a game animal. Game animals may include, for example, deer, elk, antelope, moose, goats, sheep, boar, and the like. In at least one aspect of the invention, the game animal is a horned, or antlered, game animal, e.g., deer, elk, antelope, moose, and the like. The sculpture may form the likeness of the entire game animal or, in one aspect, may form the likeness of only the head and neck portion of the game animal. Optionally, the sculpture may form the likeness of any portion of the game animal as desired by the practitioner.

Turning now to the Figures, certain aspects of the present invention are illustrated therein. As shown in the Figures, the sculpture 10 includes a re-created head portion 12 and neck portion 14 of the game animal, illustrated therein as a deer. In one aspect of the invention, the sculpture includes at least a re-created game animal head portion sculpted, textured, molded, and/or painted to substantially conform to the shape, dimensions and, optionally, color of the head portion of the game animal. The sculpture may be formed from a variety of materials. In one aspect of the invention, the sculpture is formed from polyurethane foam. Other suitable materials may include, for example, elastomers, polyester resins, and the like. In order to substantially resemble the appearance of the game animal, the sculpture may be sculpted, textured, molded, and/or painted as described above. It should be understood that those of ordinary skill in the art may use any of the above-mentioned methods alone or in combination to form the sculpture of the game animal, but other methods known to those of skill in the art may also be employed. Additionally, the sculpture may be formed from one piece or may be formed from multiple pieces and assembled to form the sculpture. For example, the ears and/or eyes of the re-created game animal may be formed separately and attached to the head portion of the sculpture. The sculpture may substantially resemble the appearance of the game animal provided by the sportsman or may substantially resemble a representative specimen of the game animal as found in nature.

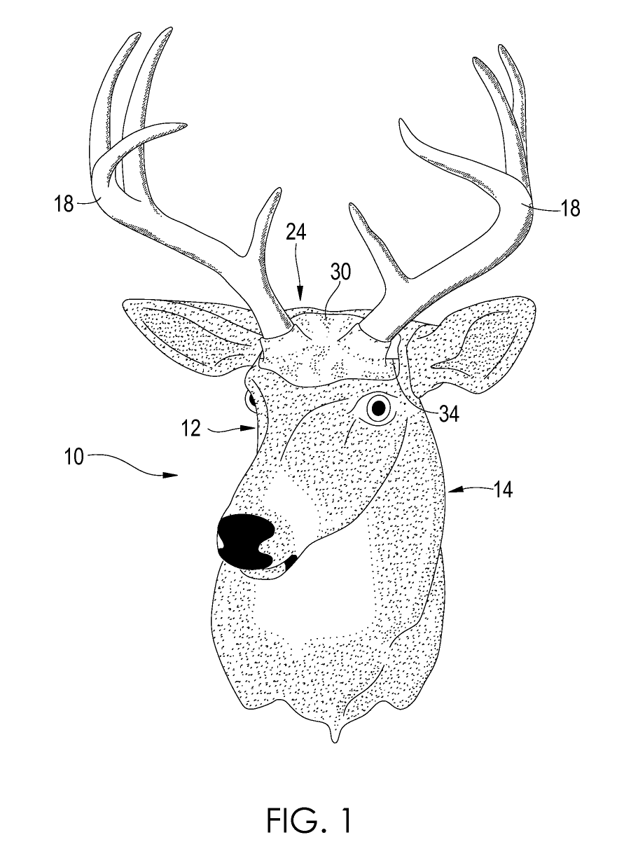

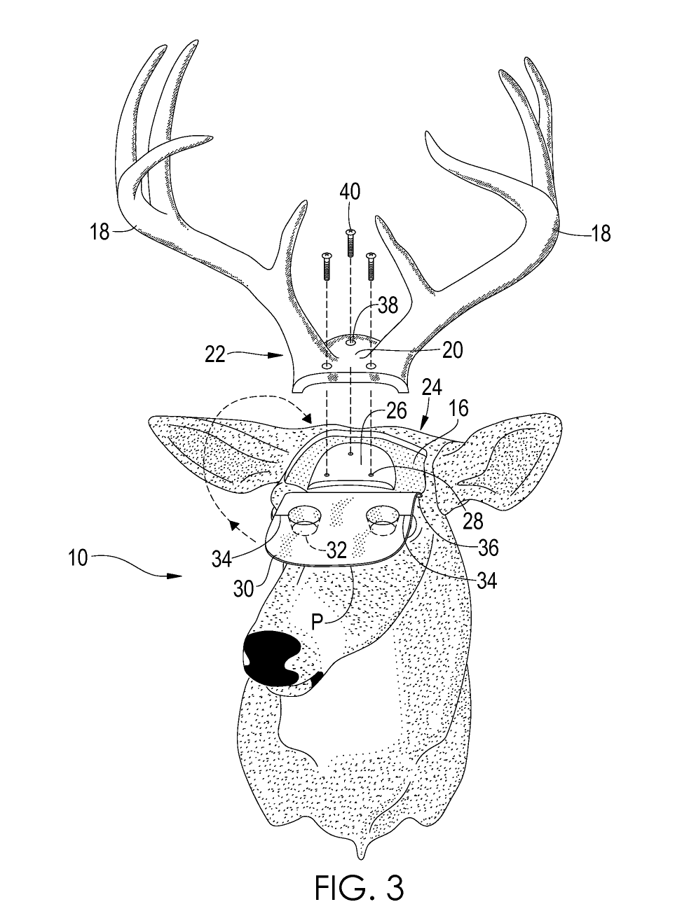

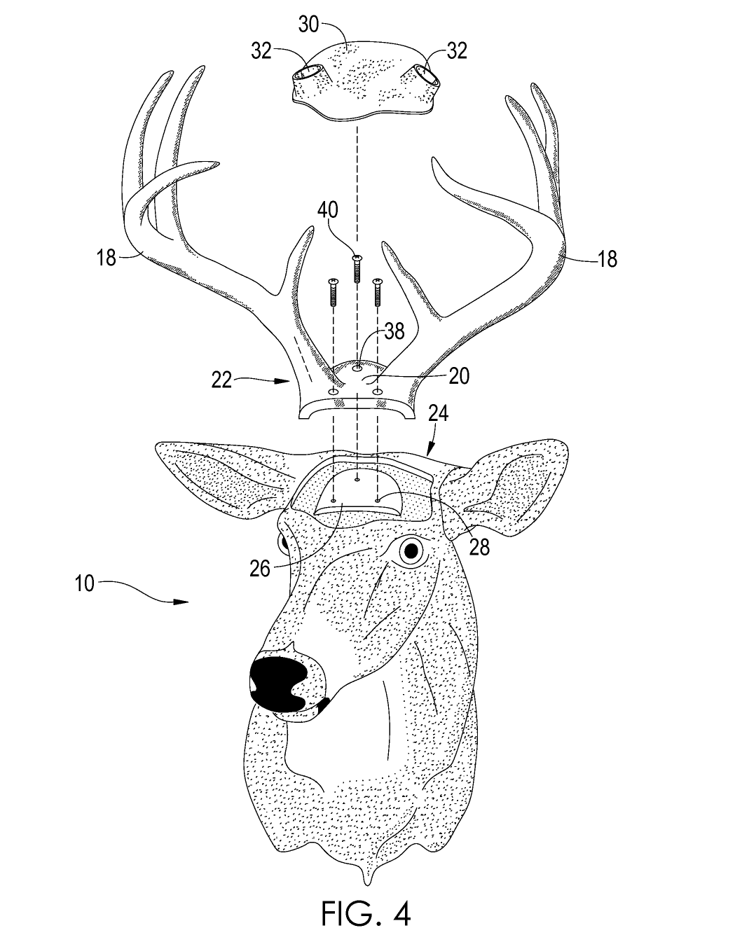

As shown most clearly in FIGS. 3 and 4, the re-created game animal head portion 12 defines a cavity 16 sized and configured to receive at least one appendage 18 of the game animal. As shown in the FIGS. 1, 3, and 4, the sculpture includes a plurality of appendages 18, illustrated as a pair of antlers. For purposes of this application, the terms horn and antler may be used interchangeably. Antlers or horns may comprise a branch or multiple branches, wherein each branch ends in a point. In alternate aspects of the invention, the appendage may include a tusk, spur, and the like, the appendage being dependent on the particular species of game animal to be re-created. As shown in FIGS. 3 and 4, each antler 18 is coupled to a shared portion of the skull 20 of the game animal, thereby forming a unitary antler set 22. Optionally, each antler may be coupled to a respective portion of the skull of the game animal or each antler may not be coupled to any portion of the skull of the game animal.

In an aspect of the present invention shown in FIGS. 3 and 4, the re-created game animal head portion 12 defines a cavity 16 at a top portion 24 of the re-created game animal head portion located proximate the ears and eyes of the re-created game animal, more specifically, at the corresponding general location of the antlers of the game animal. A mounting surface 26 is disposed within the cavity 16 of the re-created animal head portion 12. As shown in FIGS. 3 and 4, the mounting surface 26 is formed from the re-created animal head portion 12; however, in alternate aspects of the invention, the mounting surface may be attached to the re-created animal head portion in the form of a mounting plate. Such mounting surface or plate may define at least one mounting aperture As shown in FIGS. 3 and 4, the mounting surface 26 defines a plurality of mounting apertures 28.

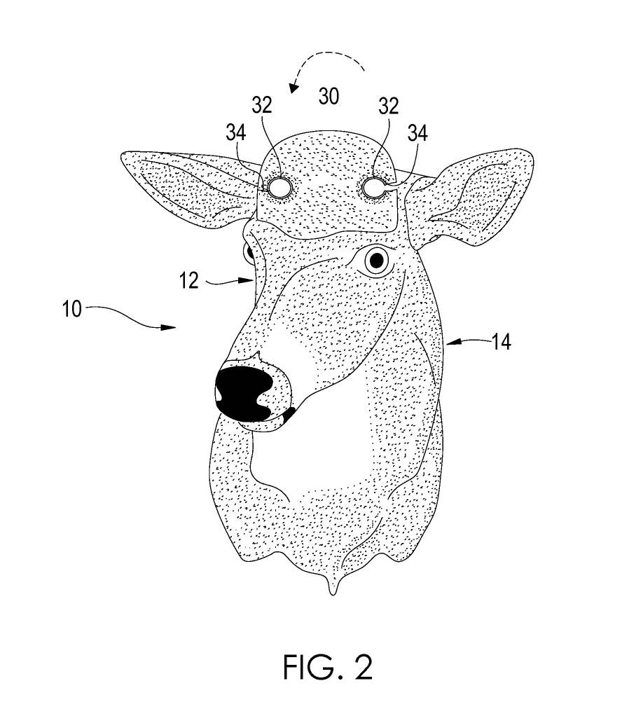

As shown in the Figures, a cover 30 is sized and configured to be positioned over at least a portion of the cavity 16. As illustrated in FIG. 1, the cover 30 is shown disposed over the entire portion of the cavity 16 after the antlers 18 have been disposed within the cavity, which will be discussed in further detail below. The cover 30 may be formed from the re-created game animal head portion 12 and configured to be partially detachable from the re-created game animal head portion, such that the cover as partially attached to the re-created game animal head portion forms a flexible flap as shown in FIGS. 2 and 3. The cover 30, or flap as it is referred to when partially attached to the re-created game animal head portion, is formed such that the flap 30 may be positioned over at least a portion of the cavity 16, as shown in FIG. 1, or may be positioned such that the cavity 16 is exposed, as shown in FIGS. 2 and 3. Optionally, the cover 30 may be detachably attachable to the re-created game animal head portion 12 as shown in FIG. 4. In certain aspects of the invention, the cover may be rigid.

The cover, or flap, 30 defines at least a portion of at least one appendage opening 32 in at least one aspect of the invention. Each appendage opening 32 is sized and configured such that a portion of each appendage 18 may be disposed within and extend through a respective appendage opening. In certain aspects of the invention, the cover, or flap, defines a plurality of appendage openings. As shown in the Figures, a slit 34 is formed in the flap, or cover, 30 from an edge portion of the flap, or cover, to each respective appendage opening 32. Each slit enables the respective appendage to be disposed within and extend through the respective appendage opening.

In at least one aspect of the invention, a method is provided for providing a sculpture of the game animal, including mounting at least one appendage of the game animal to a re-created game animal head portion of a sculpture of at least a portion of the game animal. The sculpture 10, illustrated as a sculpture of a deer, is shown in its completed state in FIG. 1. Looking now at FIGS. 2 and 3, the sculpture 10 includes the re-created deer head portion 12 and neck portion 14. The top portion 24 of the re-created deer head portion 12 defines a cavity 16, wherein a mounting surface 26 is disposed with the cavity, the mounting surface formed from the re-created deer head portion. A cover 30, illustrated as a flap, is formed from the re-created deer head portion 12 and is partially detached from the re-created deer head portion, the junction of the attached portion of the flap and the detached portion of the flap creating a hinged portion 36. To mount at least one appendage 18, optionally, a plurality of appendages of the game animal, illustrated in FIG. 3 as a pair of antlers, to the re-created deer head portion 12, the flap 30 is rotated about the hinged portion 36 toward the nose of the re-created deer head portion such that the cavity 16 is exposed (FIGS. 2 and 3 in sequence).

As shown in FIG. 3, each antler 18 is coupled to a shared portion of the skull 20 of the deer, forming a unitary antler set 22. The skull portion 20 defines a plurality of antler apertures 38 configured to align with the respective mounting apertures 28 defined by the mounting surface 26 of the re-created deer head portion 12. The unitary antler set 22 is disposed within the cavity 16 such that the skull portion 20 of the unitary antler set is flush with the mounting surface 26 and each antler aperture 38 aligns with a respective mounting aperture 28. Fasteners 40, such as screws illustrated in FIGS. 3 and 4, are threaded through the antler apertures 38 and mounting apertures 28 and into the mounting surface 26 of the re-created deer head portion 12, thereby attaching the unitary antler set 22 to the re-created deer head portion 12. Optionally, the re-created game animal head portion may define at least one re-created game animal head mount opening, wherein an appendage, e.g., antler, may be disposed within the re-created game animal head mount opening.

As shown in FIG. 3 and most clearly in FIG. 1, the flap 30 is disposed over the cavity 16 such that the sculpture 10 substantially resembles the deer provided by the sportsman (not shown). In order to dispose the flap 30 over the cavity 16 and unitary antler set 22, the flap is rotated about the hinged portion 36 away from the nose of the re-created deer head portion 12 and over the cavity. The slit 34 in the appendage openings 32 allow for each antler 18 to be disposed within each respective appendage opening 32. The perimeter area P of the flap 30 is aligned with the edges of the cavity 16 so that the flap is flush with the surface of the re-created deer head portion 12. Optionally, the flap may be modified to be positioned over the cavity when the antlers are disposed within the cavity. Such modifications may be needed based on the size and dimensions of the antlers provided from the game animal.

As shown in FIG. 4, the cover 30 may be detachable attachable to the re-created deer head portion 12. In such aspects of the invention, the cover 30 is disposed over the cavity 16 after the unitary antler set 22 has been attached to the mounting surface 26 of the re-created deer head portion 12. In at least one aspect of the invention, the detachably attachable cover is formed from a rigid material.

In at least one aspect of the invention, the sculpture of the game animal may be mounted to a wall for display.

In at least one aspect of the invention, the sculpture of the game animal may be configured to place on a table top or configured as a pedestal display.

Optionally, in alternate aspects of the present invention, the re-created game animal head portion may define the cavity at varying portions of the re-created game animal head portion depending on the placement of the appendage therein. Such locations of cavities may depend on the species of game animal to be re-created. For example, if the game animal to be re-created is a boar, such a re-created boar head portion would define the cavity proximate the snout portion of the re-created boar head portion, such that the appendages, i.e., tusks may be disposed therein. Additionally, if the portion of the game animal, e.g., turkey, to be re-created includes the leg portion of the turkey, the re-created leg portion of the turkey may define a cavity sized and configured to receive an appendage, e.g., spur or foot, to be disposed within the cavity.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation within the spirit and scope of the appended claims.

That which is claimed is:

1. A sculpture of at least a head portion of a game animal, the sculpture comprising
at least a re-created game animal head portion sculpted, textured, molded, and/or painted to substantially conform to the shape, dimensions and, optionally, color, of at least the head portion of the game animal, wherein the re-created game animal head portion defines a cavity sized and configured to receive at least one appendage of the game animal, and
a cover sized and configured to be positioned over at least a portion of the cavity, such that when the appendage is received in the cavity of the re-created animal head portion and the cover is disposed over the cavity, the sculpture substantially resembles at least the head portion of the game animal.

2. The sculpture of claim 1 wherein each appendage is detachably attachable to the re-created game animal head portion.

3. The sculpture of claim 2 wherein the cover is formed from the re-created game animal head portion.

4. The sculpture of claim 3 wherein the cover is partially detachable from the re-created game animal head portion.

5. The sculpture of claim 4 wherein the cover defines at least a portion of at least one appendage opening, each appendage opening sized and configured such that a portion of each appendage may be disposed within and extend through a respective appendage opening.

6. The sculpture of claim 2 wherein the cover is detachably attachable to the re-created game animal head portion.

7. The sculpture of claim 6 wherein the cover defines at least a portion of at least one appendage opening, each appendage opening sized and configured such that a portion of each appendage may be disposed within and extend through a respective appendage opening.

8. The sculpture of claim 7 wherein the cover comprises a rigid material.

9. The sculpture of claim 1 wherein each appendage comprises an antler coupled to a portion of the skull of the game animal.

10. The sculpture of claim 1 further comprising a plurality of appendages, each appendage comprising an antler wherein each antler is coupled to a portion of the skull of the game animal, the portion of the skull of the game animal being detachably attached to the re-created game animal head portion.

11. The sculpture of claim 1 further comprising a mounting surface coupled to the sculpture.

12. The sculpture of claim 1 wherein the game animal is selected from the group consisting of a deer, an elk, an antelope, and a moose.

13. A method of mounting at least one appendage of a game animal to a re-created game animal head portion of a sculpture of at least a head portion of the game animal, the method comprising
disposing a portion of each appendage in a cavity defined by the re-created game animal head portion, wherein the re-created game animal head portion is sculpted, textured, molded, and/or painted to substantially conform to the shape, dimensions and, optionally, color of at least the head portion of the game animal and the cavity is sized and configured to receive the portion of each appendage of the game animal;
attaching the portion of each appendage of the game animal to the re-created game animal head portion; and
disposing over the cavity a cover sized and configured to be positioned over at least a portion of the cavity,
whereby the sculpture substantially resembles at least the head portion of the game animal.

14. The sculpture of claim 13 wherein the cover is formed from the re-created game animal head portion.

15. The sculpture of claim 14 wherein the cover is partially detachable from the re-created game animal head portion.

16. The sculpture of claim 15 wherein the cover defines at least a portion of at least one appendage opening, each appendage opening sized and configured such that a portion of each appendage may be disposed within and extend through a respective appendage opening.

17. The method of claim 13 wherein the cover is detachably attachable to the re-created animal head portion.

18. The method of claim 13 further comprising modifying the cover to be positioned over the cavity when the appendage is disposed within the cavity.

19. The method of claim 13 further comprising securing substantially all of the perimeter area of the cover to the re-created game animal head portion.

20. The method of claim 13 wherein the game animal is selected from the group consisting of a deer, an elk, a moose, and an antelope.
